(19) United States
(12) Patent Application Publication
(10) Pub. No.: US 2023/0056393 A1
(43) Pub. Date: Feb. 23, 2023

(54) APPARATUS FOR THERMAL REGULATION OF A HIGH TEMPERATURE PEM FUEL CELL STACK

(71) Applicant: ADVENT TECHNOLOGIES INC., Boston, MA (US)

(72) Inventors: Nikolaos G. THEODOROPOULOS, Patras (GR); Thomas J. PAVLIK, Stanwood, WA (US); Emory S. De Castro, Nahant, MA (US); Nora GOURDOUPI, Patras (GR); Vassilios GREGORIOU, Drosia (GR)

(21) Appl. No.: 18/048,274

(22) Filed: Oct. 20, 2022

Related U.S. Application Data
(63) Continuation of application No. PCT/US2020/034123, filed on May 22, 2020.

(51) Int. Cl. H01M 8/04029; H01M 8/04007; H01M 8/2425; H01M 8/1004

(52) U.S. Cl. CPC H01M 8/04029; H01M 8/04067; H01M 8/2425; H01M 8/1004; H01M 2008/1095

(57) ABSTRACT

The present invention provides fuel cell stacks comprising effective means to maintain the fuel cell stacks at a constant temperature using plates mated to at least one face of the stack and in contact with the edges of the repeat and non-repeat layers while making use of the phase change of working-fluids such as water or water-organic species mixtures for heat transfer. Also provided are processes for maintaining said fuel cell stacks at a constant temperature by adjusting the flow rate and pressure of the cooling fluid so that both liquid and vapor are present at the same time.

### TECHNICAL FIELD

This invention relates generally to fuel cells, and more particularly to an apparatus and methods for thermal regulation of a high temperature polymer electrolyte membrane (HTPEM) fuel cell stack.

### BACKGROUND OF THE INVENTION

Fuel cell stacks may typically be comprised of repeating layers, with one of the layers being an electrically non-conductive electrolyte membrane through which an ion species may be transported under the influence of a thermodynamic potential. Electrodes are applied to the membrane faces. In the fuel cell these membrane-electrode-assemblies (MEAs) are sandwiched between electrically and thermally conductive bipolar-plates.

It is typical for MEAs to have frames integrated onto them to ease subsequent integration of the MEA assembly into a fuel cell stack. Sealing is typically accomplished within the frame region.

The combination of the bipolar plates and the MEA defines a cell. The bipolar-plates have means such as channels for routing of an oxidant gas to one face of the MEA and for routing of fuel gas to the other face of the MEA. The fuel cell stack allows for a specific reaction of the oxidant and fuel with the products of the reaction being a flow of electrons and water and with heat being generated through the fuel cell reaction.

Fuel cell stacks must operate within a specific temperature range to allow for maximum performance and reliability. For example, the temperature of a high temperature PEM (HTPEM) fuel cell stack must be maintained between about 120° C. and 200° C., with a preferred range being between about 155° C. and 175° C. It is well known that operating a stack with hot and/or cold zones will shorten the lifetime and decrease the performance of a stack, so any means possible to maintain as uniform a temperature as possible is a critical design criterion. This is especially critical when the operational temperature is above 100° C.

To maintain the stack at a suitable operating temperature the bipolar plates may be of a two-piece design with a fluid circuits disposed onto a face opposite of the face having a reactant circuit. The purpose of the fluid circuit being to route a working fluid for the transferring of thermal energy away from or to the active region. When the bipolar plate halves are clamped together the fluid circuit is sealed inside and between the plates.

A complication of routing liquid coolants through the stack is that such an architecture requires that three species are sealed; the anode and cathode reactants, as well as the coolant. Additional seals present a reliability risk.

Due to the operating temperature of HTPEM fuel cell stacks, the choice of working fluids flowing inside it is limited. Specialized heat transfer fluids are therefore used for HTPEM stacks, one brand name being Dowtherm which can be relied upon for stable performance up to 288° C.

Dowtherm and other heat transfer fluids such as Fluorinert FC-70 which is rated for use up to 215° C. present challenges for sealing, both in terms of materials compatibility with common elastomers and in terms of the propensity that these fluids have for leaking. This difficulty arises due to the wetting/wicking behavior exhibited by these fluids. Also some fluids which are suitable for use at the operating temperature of HTPEM stacks contain toxic components which can pose hazards to the environment when leaks occur or during disposal.

A distinct advantage could be gained if water or a water-organic mix could be used as the working fluid. Additionally, heat transfer through vaporization of the water could provide an advantage because of the efficiency of cooling associated with the phase change. But the flow circuit allowing for phase change inside the stack would complicate the stack design. For example a stack cooled via phase-change inside the stack would need to withstand relatively high internal pressure. Such high pressure being required for the vaporization at the designed operating temperature would be, place great demands on the seal design.

U.S. Pat. No. 6,866,955 B2 details use of a phase change for cooling stacks that operate under 120° C. and 2 bar whereby internal coolant paths are along the plane of the bipolar plates engendering the complication of routing liquid coolants through the stack and the requirement that three species are sealed (air, hydrogen, and coolant), which is more difficult for operating when the cooling loop pressures and temperatures climb over the limits of 2 bar and 100° C. cited in this patent.

For stacks with a coolant flowing internally; the electrical conductivity of such a working fluid flowing through internal passages in the stack may increase as conductive particles, shed by the stack or other system elements become entrained in the flow. As the concentration of conductive particles in the fluid stream increases, the risk of internal shorting in the stack increases. To address these risks, filters or deionization beds may be included in the system. Each of these adds expense and complexity to the system, these require maintenance and increase the pressure drop in the coolant loop, necessitating a larger pump, which adds expense and which produces more acoustical noise.

### SUMMARY OF THE INVENTION

The inventors have unexpectedly found that a solution to the above problems of cooling higher temperature stacks arises from the novel combination of two approaches to stack cooling: conductive transfer of heat from at least one face with that face being comprised of the edges of the stack repeat elements, and flowing a high thermal capacity coolant as a working-fluid while maintaining two phases in that coolant. This solution is an effective means to externally cool HTPEM fuel cell stacks with simplified and reliable hardware geometries and using water or water organic species mixtures as working-fluids and to make use of a phase change for heat transfer.

In one embodiment a thermal-mass incorporating a fluidic-circuit is mated to the stack exterior. The thermal-mass receives heat power from the stack, which vaporizes a working-fluid in the fluidic-circuit. The flow of the working-fluid through the fluidic-circuit is adjusted to ensure that an excess is present so that the flow is not completely converted to the vapor phase, with some liquid remaining. The flow is routed from the thermal-mass to a heat exchanger where vapor is condensed to liquid and where the temperature of the working-fluid may decrease.

In a second embodiment a thermal-mass incorporating a fluidic-circuit is mated to the stack exterior. The thermal-mass receives heat power from the stack, which vaporizes a working-fluid in the fluidic-circuit. The flow of the working-fluid through the fluidic-circuit is adjusted to ensure that an excess is present so that the flow is not completely converted to the vapor phase, with some liquid remaining. The pressure in the fluidic-circuit is additionally adjusted to achieve a specific saturation temperature in the two-phase flow. The flow is routed from the thermal mass to a heat exchanger where vapor is condensed to liquid and where the temperature of the working-fluid may decrease.

The present apparatus and methods achieve several advantages with respect to the prior art, namely a cooling system with a very high capacity for heat removal, which reduces the complexity of cooling systems, reduces the total weight of the cooling system, reduces the parasitic power loss for pumping the cooling fluids, and, perhaps most importantly, vastly simplifies the design of the bipolar plates by eliminating the need to construct either additional cooling elements with the stack power creating elements, or incorporating interstitial cooling volumes as part of the bipolar plates and thus engendering cooling fluid leaks.

### IN THE DRAWINGS

FIG. 1 is an isometric view of the fuel cell stack according to a first embodiment of the present disclosure.

FIG. 2 is an exploded isometric view of the fuel cell stack of FIG. 1.

FIG. 3 is a diagram of a piping-circuit for the working-fluid, which receives heat from and transfers heat to the fuel cell stack of FIG. 1

FIG. 4 is an isometric view of the thermal-mass with a fluidic-circuit.

FIG. 5 is an isometric cross-sectional view of the thermal-mass with fluidic-circuit.

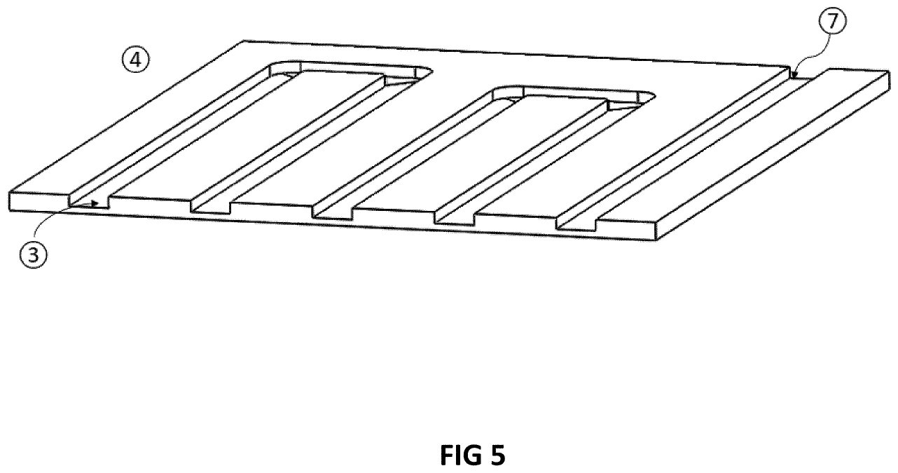

FIG. 6 depicts a Boyd Corporation, Lytron, pressed tube cold plate.

### DETAILED DESCRIPTION OF THE INVENTION

The term “thermal-mass” as used herein denotes a monolithic plate which may receive and release thermal energy. In the present disclosure, the thermal-mass may freely exchange thermal energy with a fuel cell stack to which it is intimately mated.

The present disclosure is generally directed to the use of a thermal-mass incorporating a fluidic-circuit adapted to provide a constant temperature reservoir with which a fuel cell stack may exchange thermal energy. The pressure in the fluidic-circuit is adjusted so that the temperature of the two-phase flow corresponds to a specified saturation temperature. The presence of two-phases ensures that the thermal-mass and the exterior of the stack that it is mated to, are each maintained at a constant temperature.

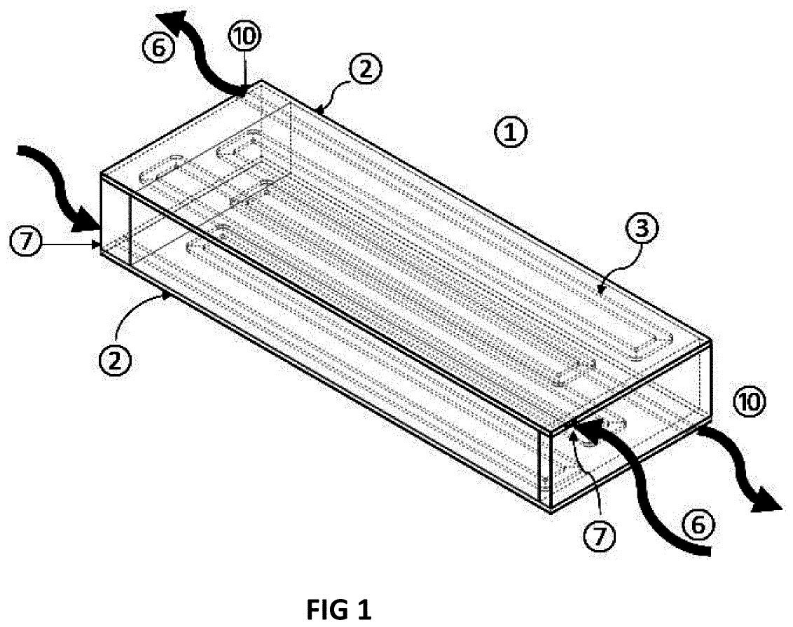

Depicted in FIG. 1 according to a first embodiment of the present disclosure, the fuel cell stack, 1 is comprised of bipolar plates stacked in series with membrane electrode assemblies (MEAs) between the bipolar plates and with all of these components being between end plates situated at the opposite ends of the stack. The combination of bipolar plates and MEAs repeating and forming a face 9.

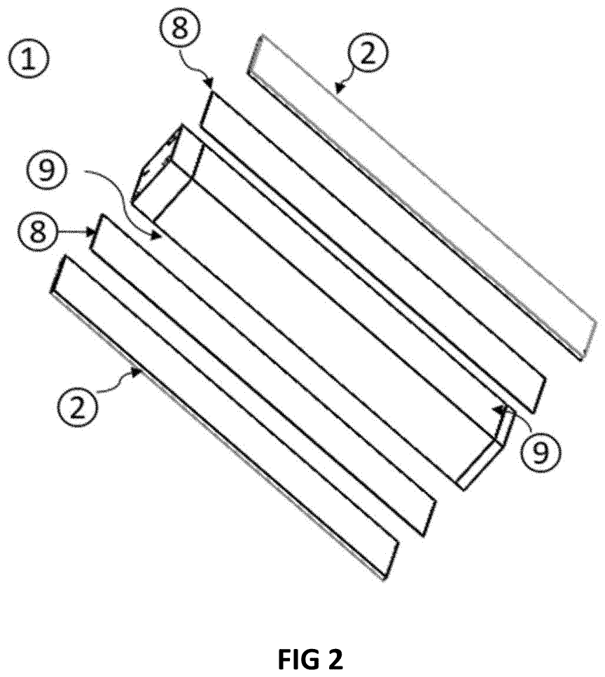

Referring to FIG. 2 at least one thermally-conductive, dielectric layer 8 is disposed on at least one face 9 of the fuel cell stack 1 a second thermally-conductive, dielectric layer 8 may be disposed on a second face 9 of the fuel cell stack. Additional thermally-conductive, dielectric layers 8 may be introduced onto additional faces of the fuel cell stack. In one suitable embodiment, the thermally-conductive, dielectric layer 8 is comprised of one of several commercially available materials which have a thru-the-plane thermal conductivity of between about 3 W/m*K and 15 W/m*K. Such materials are available as sheets of plastic or elastomer or from combinations of polymers and minerals.

At least one thermal-mass 2, incorporating a fluidic-circuit 3 is mated to the at least one face 9 of the fuel cell stack with the thermally-conductive dielectric layer 8 disposed between the thermal-mass 2 and the fuel cell stack, 1 for the purpose of routing thermal energy while preventing electrical contact. and a second thermal-mass 2 having a second fluidic-circuit 3 is mated to a second face of the fuel cell stack in like manner. In a related embodiment the fuel cell stack can have just one thermal-mass mated to just one face or multiple thermal-masses mated to multiple faces.

When thermal loads are present such as when heat is applied to the stack 1 during start-up or during other operation accompanied by a change in temperature such as shut-down, the stack 1 will expand or contract. Such thermal expansion or contraction varies among materials. During thermal expansion or contraction, when frictional forces are present between the thermally-conductive dielectric layer and an adjacent face of the stack 9 or between the thermally-conductive dielectric layer and the face of a thermal-mass 2 such forces and displacement can be great enough to deform, tear or otherwise damage the thermally-conductive dielectric layer. In one preferred embodiment a thermally-conductive dielectric grease is applied to the at least one face of the thermally-conductive dielectric layer 8 for the purpose of lubricating the interface between the thermally-conductive dielectric layer 8 and the face of the stack 9 or between the thermally-conductive dielectric layer 8 and the thermal-mass 2. In one preferred embodiment both faces of the thermally-conductive dielectric layer are coated with a lubricant. The purpose of the lubrication being to allow sliding to occur between the thermally-conductive layer and adjacent components so that it does not tear under the influence of frictional forces.

The fuel cell stack 1 produces thermal energy as a byproduct of its operation. This thermal energy must be removed if the stack is to continue to operate. The thermal energy may flow be removed by the thermal-mass 2 with said thermal energy elevating the temperature of a working-fluid 6 which enters the fluidic-circuit 3 in the thermal mass 2 through inlet 7 and which exits through outlet 10. The thermal energy is absorbed by the working-fluid 6 through the elevation of the temperature of the working-fluid 6 through a process called sensible heat transfer up until the working fluid 6 reaches to its boiling (vaporization) point. Thereafter additional thermal energy is absorbed by the working-fluid 6 which vaporizes and absorbs thermal energy from the stack 1 through a process termed latent heat transfer.

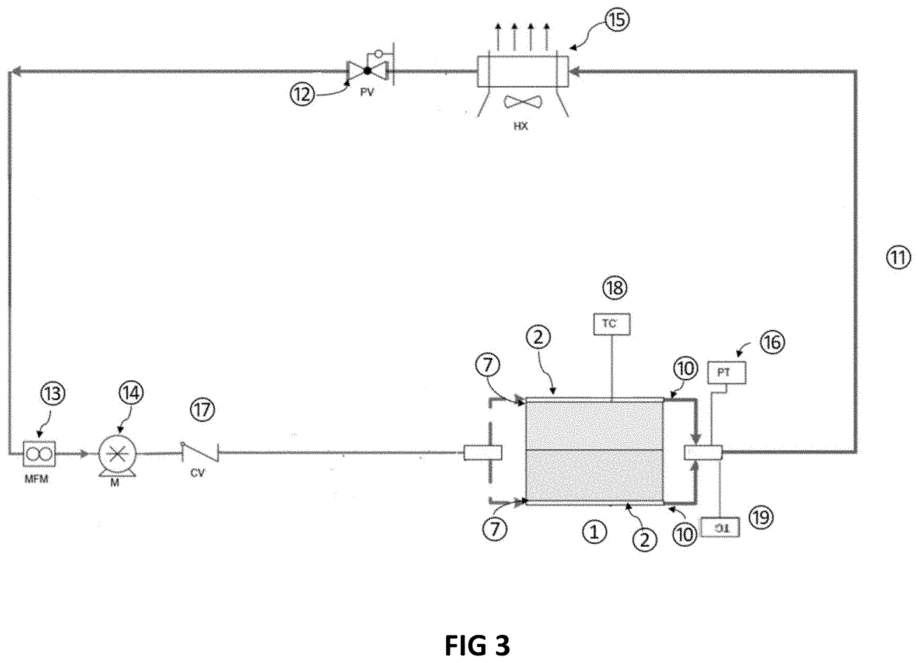

Referring to FIG. 3 the working-fluid 6 flows through a piping-circuit 11. In one embodiment a pressure regulator 12 is adjusted so that the pressure in the piping-circuit 11 corresponds to the vaporization saturation temperature of working-fluid 6 such as approximately 5.52 Bar for water to vaporize at 160C. In one embodiment the pressure regulator 12 is controlled via feedback from pressure transducer 16.

A prescribed working-fluid 6 temperature is achieved through assurance of the presence of both the liquid and gas phases. So long as the two phases are each present, the temperature will be constant but if one of the phases is absent then the temperature may not be constant. For example, it is possible for a working-fluid 6 to be at a temperature below the saturation temperature of the working-fluid 6 if only liquid is present. Such a liquid is termed “supercooled”. Also, for example it is possible for a working-fluid 6 to be at a temperature above the saturation temperature of the working-fluid if only a vapor is present. Such a vapor it termed “superheated.”

Referring to FIG. 3, one means to assure the presence of both the liquid and vapor phases (steam quality between zero and 100 percent, or as defined in chemical engineering between zero and one) at the saturation temperature, is to employ a piping circuit having a pump 14 delivering working-fluid 6 to the thermal-mass 2, which is receiving thermal energy from stack 1, at a rate which maintains the temperature at thermocouple 19 at the prescribed vapor saturation temperature with some additional flow being provided to ensure that the flow does not consist entirely of vapor at its saturation temperature. In one suitable embodiment, the steam quality is best maintained between 10 percent and 90 percent, more suitably between 20 and 80 percent even more suitably between 30 and 70 percent, and most suitably between 40 and 60 percent.

Pump 14 flow may be controlled via a signal from Mass flow meter 13 with the amount of flow supplied being a function of the output of thermocouples 19 which measures the temperature immediately downstream of thermal-mass 2 which is at a substantially identical temperature to working fluid 6 and (referring to FIG. 1) stack face 9 as measured by thermocouple 18. Flow in such a piping circuit is assured in the design direction only through a check valve 17. The flow is adjusted so that the temperature at thermocouple 19 is at the saturated vapor temperature of the working-fluid. Then additional flow is provided at a pre-set amount to ensure that the flow does not consist only of vapor. For example if 50 grams of water per minute are required to maintain thermocouple 19 at the saturated vapor pressure, then 55 grams of water may be provided to ensure that the flow consists of two phases and thus ensures a constant temperature.

In one preferred embodiment a condensing heat exchanger 15 is introduced in the piping-circuit to change the phase of the working-fluid to 100 percent liquid and which may also reduce the temperature of the working-fluid to below its saturation temperature. The working fluid may thus be used in a continuous loop.

The piping circuit may have some of the elements shown in FIG. 3 removed or additional components may be added such as storage tanks, accumulators, pressure relief valves and other process piping components without departing from the present disclosure.

The temperature of thermal-mass 2 may be maintained at a substantially uniform temperature throughout its volume by employing as the material of its construction one having a high thermal conductivity. For example 6063 aluminum alloy has a thermal conductivity of about 200 Watts*m⁻¹*K⁻¹ and copper 81100 alloy has a thermal conductivity of about 345 Watts*m⁻¹*K⁻¹.

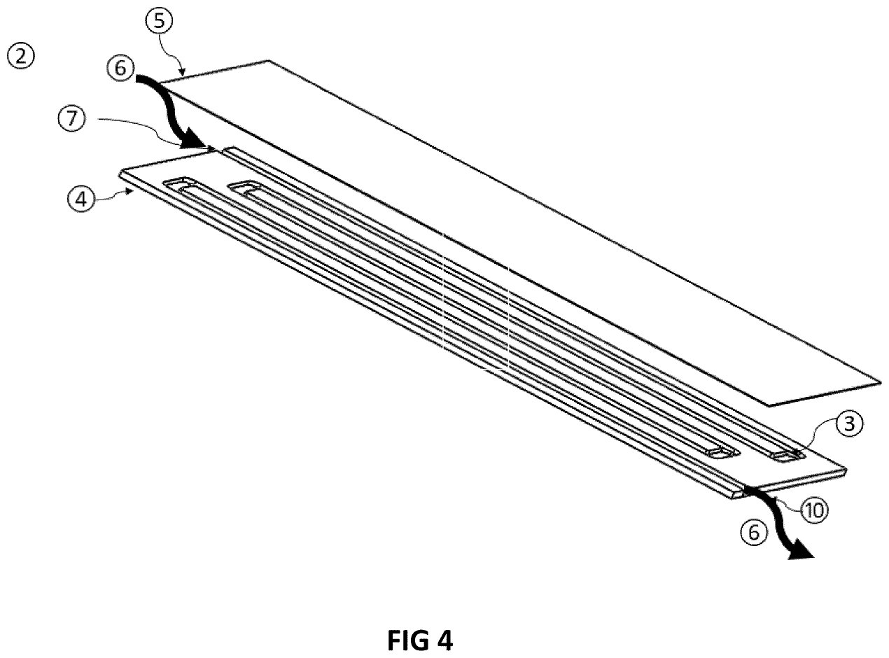

Referring to FIG. 4, direct thermal contact between thermal-mass 2 and working-fluid 6 may be achieved through one embodiment in which fluidic-circuit 3 is integral to thermal-mass 2 such as in the case of channels being machine-cut into thermal-mass 2 or in the case of thermal mass 2 being fabricated through a casting or molding operation with the thermal circuit being produced through features in the die or mold. In one embodiment the thermal mass 2 consists of a base plate 4 and a cover plate 5. In one preferred embodiment the cover plate 5 may be affixed to base plate 4 through a welding process such as laser welding.

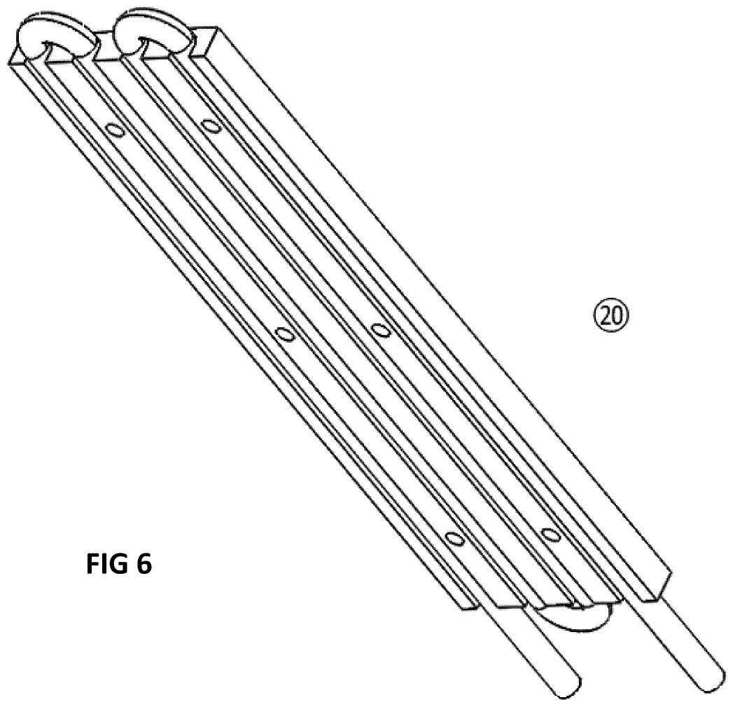

Referring to FIG. 6. In one embodiment the fluidic-circuit 3 in the thermal mass 2 may be a separate or discreet component that is intimately mated to thermal-mass 2 to minimize thermal contact resistance. The Lytron division of the Boyd Corporation in Pleasanton Calif. produces “pressed tube cold plates” of such configuration as shown in 20.

1. A fuel cell stack comprised of
Repeating bipolar plates and MEAs and non-repeating layers, of end plates
One or more plates mated to the at least one face of the stack and in contact with the edges of the repeat layers, said one or more plates being adapted to act as a constant temperature thermal reservoir.

2. The stack of claim 1 wherein the said plate incorporates a working-fluid flowing within a fluidic-circuit

3. The stack of claim 2 wherein the working-fluid water, or mixtures of water and propylene glycol, water and ethylene glycol, water and methanol, or water and ethanol.

4. The stack of claim 1 wherein the operating temperature of the stack is between 120C and 260C.

5. The stack of claim 3 wherein the pressure within the fluidic-circuit is adjusted to be the saturated vapor pressure of the working-fluid at the stack operating temperature.

6. The stack according to claim 3, wherein the steam quality of the mixture is adjusted to be between 5 percent and 95 percent.

7. The stack of claim 5 in which excess flow is introduced into the fluidic circuit to ensure the presence of both liquid and vapor phases.

8. The stack of claim 1 in which a thermally-conductive dielectric layer is disposed between the constant temperature thermal reservoir plate and the face of the stack

9. The stack of claim 7 in which a lubricant is disposed on the at least one face of the thermally-conductive dielectric layer.

10. The stack of claim one in which a lubricant is disposed onto the at least one face of the at least one thermally conductive dielectric layer.
